(19) United States
(12) Patent Application Publication
(10) Pub. No.: US 2019/0294962 A1
(43) Pub. Date: Sep. 26, 2019

(54) IMPUTATION USING A NEURAL NETWORK

(71) Applicant: Microsoft Technology Licensing, LLC, Redmond, WA (US)

(72) Inventors: Árpád VEZER, London (GB); Douglas Alexander Harper ORR, London (GB); Osman Ibrahim Osman RAMADAN, London (GB)

(21) Appl. No.: 15/973,525

(22) Filed: May 7, 2018

(30) Foreign Application Priority Data
Mar. 20, 2018 (GB) 1804433.9

(51) Int. Cl. G06N 3/08; G06N 7/00; G06N 5/04

(52) U.S. Cl. CPC G06N 3/08; G06N 5/048; G06N 7/005

(57) ABSTRACT

A method of automatically imputing missing or erroneous data. The method comprises dividing a portion of input data (e.g. a sentence) into a sequence of smaller elements (e.g. words), and identifying points in the sequence at which missing or erroneous data is potentially to be imputed. For each point, a first search step generates a respective set of one or more paths for the respective point, each path comprising a candidate element to potentially replace the missing or erroneous data at the respective point, and an associated probability score generated by a neural network. In each subsequent search step for each point, a set of one or more of the preceding paths from one or more of the preceding search steps are selected to extend with an additional candidate element and score again. The paths are compared from across the different search steps to select at least one for output.

### FIELD

The present disclosure relates to the use of artificial neural networks for the purpose of imputation.

### BACKGROUND

Imputation refers to the art of inferring substitute data to insert into the position of missing or erroneous data in a data sequence, e.g. a missing word in a sentence input by a user. Nowadays it is known to perform imputation using machine intelligence algorithms such as neural networks.

A neural network comprises a graph of interconnected nodes, typically implemented in software in the case of an artificial neural network as in the present disclosure. Each node has one or more inputs and one or more outputs, with at least some of the nodes having multiple inputs per node, and at least some of the nodes having multiple outputs per node. The inputs of one or more of the nodes form the input to the graph, and the outputs of one or more of the nodes form the output of the graph. Further, the outputs of at least some of the nodes are connected to the inputs of at least some others of the nodes. The connections between nodes are sometimes also referred to as edges or vertices.

Each node represents function of its inputs, the outputs of the function being the outputs of the node, such that the outputs of the node depend on its inputs according to the respective function. The function of each node is also parametrized by one or more respective parameters, sometimes also referred to as weights (not necessarily weights in the sense of multiplicative weights, though that is one possibility). Thus the relation between the inputs and outputs of each node depends on the respective function of the node and its respective parameters.

Before being used in an actual application the neural network is first trained for that application. Training comprises inputting experience data to the input of the graph and then tuning the parameters of the nodes based on feedback from the output of the graph. The experience data comprises multiple pieces of input data, i.e. multiple input data points each comprising a vector of values corresponding to the individual input vertices of the graph. With each piece of experience data, the resulting output value(s) of the graph are observed, and this feedback is used to gradually tune the parameters of the nodes. Over many pieces of experience data the parameters tend towards values which result in the graph as a whole producing a desired or expected output for a given input. Examples of such feedback techniques include for instance back-propagation. Techniques for training a neural net are in themselves known in the art. In some case the neural net is also trained dynamically “in-the-field” by end-users, i.e. after deployment, based on feedback from the end-users themselves during actual use, though usually there will have been some initial training stage prior to actual deployment as well.

An example approach to training is the supervised approach. In this case the graph is trained using a training data set comprising multiple pieces of input experience data and, for each, a corresponding pre-determined output that would be expected from the graph. With each piece of input experience data, the predetermined training output is compared with the actual observed output of the graph. This comparison then provides the feedback which, over many pieces of training data, is used to gradually tune the parameters of the various nodes in the graph toward a state whereby the actual output of the graph will closely match the desired or expected output for a given input vector. Another approach to training is the reinforcement approach. In this case the training algorithm tries out a possible trial output for each data point in the input experience data (typically starting with random guesses then tending toward more educated guesses as the graph is gradually trained). For each trial the algorithm is informed, e.g. by a human trainer, whether this output is positive or negative (and potentially a degree to which it is positive or negative), e.g. win or lose, reward or punishment, or such like. Over many trials the algorithm can gradually tune the parameters of the graph to be able to predict inputs that will result in the desired or expected outcome. Yet another approach is the unsupervised approach. Here there is no reference output result per input data point in the experience data, and instead the training algorithm identifies its own structure in the output data.

Example applications of neural networks once trained include use as language models, such as to impute replacement data for missing or erroneous words in a sentence typed by a user. A neural network based language model can be trained to score how probable it is that a given sentence was intended by the user. Once trained this can be used to correct sentences with potentially missing or erroneous words. This is done by inputting multiple candidate variants of the sentence to the neural network language model in order to generate a respective probability score associated with each candidate, each score representing the probability that the respective candidate was what was intended by the user, or that it is grammatical or semantically correct. The scores can then be compared to determine which has the highest score, and this can be selected in place of the original input sentence.

Such techniques have the advantage, for example, of improving accuracy in text-based communications conducted over a network. Consider for instance a real-time text-based communication session such as an IM chat session: users type messages being exchanged in real-time or near real-time, which requires fast typing. However many users' accurate typing speed may not be fast enough to keep up, and hence the exchanged messages are liable to contain omissions or errors. On the other hand if the user was to slow down his/her typing, this would inhibit the real-time or near real-time nature of the exchange. Automatic imputation allows users to maintain a relatively fast typing speed while at the same time correcting errors or omissions occurring due to that speed. The imputation process could be implemented in the local client application of the sending user (e.g. IM or email client), or the client of the receiving user, or an intermediary server (e.g. IM or email server).

One challenge with imputation is in the searching part of the process, i.e. the need to pass many different candidates though the trained neural network in order to score and then compare each of those candidates (this stage that comes after the neural net has been trained). The range of candidate variants trialled in this manner is sometimes referred to as the search space. Trialling candidates from across a large search space is computationally intensive, thus either slowing down the process or incurring a larger amount of processing resources than may be desirable, or both.

### SUMMARY

Existing techniques start from the assumption that the position and quantity of the missing data is first known or is estimated to be known. If the position is known for a single word imputation, a simple search strategy is sufficient. For example, a language model is used to generate multiple candidate words in the assumed position of the missing word, and each candidate word is scored with the rest of the sequence according to the language model. However this is limited, since for a given corrupted sentence, there could in fact be multiple different possible points at which the insertion or correction of a word or character would fix the grammar or semantics of the sentence.

Some techniques do anticipate the possibility that the word could be missing from different parts of the sentence. However the search space then becomes very large and it is difficult to reduce the computational complexity of the problem, since many different candidate variants of the whole sentence need to be trialled.

It would be desirable to provide a technique that anticipates the possibility that a word or element could be missing or erroneous at multiple different positions, but which also keeps the computational complexity to a manageable level. Similar considerations may apply for other types of data sequence, not just words.

According to a first aspect disclosed herein, there is provided a computer-implemented method comprising automatically:

dividing a portion of input data into a sequence of smaller input elements;

identifying a plurality of points in the sequence at which missing or erroneous data is potentially to be imputed;

for each respective one of said points:
in a first search step, generating a respective set of one or more paths for the respective point, wherein each path comprises a candidate element to potentially replace the missing or erroneous data at the respective point, and an associated probability score, the probability score being generated by a first neural network as a function of some or all of the input elements before and/or after the respective point in the sequence, and
in each of a plurality of subsequent successive search steps, selecting a set of one or more of the preceding paths from one or more of the preceding search steps to extend, the selection being based on the associated probability scores, and generating a respective set of one or more extended paths from each respective one of the selected set of preceding paths, each extended path comprising the candidate element or elements from the respective preceding path combined with an additional candidate element, and an associated probability score for the combination, this probability score being generated by the first neural network as a function of some or all of the input elements before and/or after the respective point in the sequence, and as a function of the probability score for the respective preceding path; and

performing a comparison between at least some of the paths including comparing between paths from different ones of the search steps, and based thereon outputting a selection of one or more results wherein each result comprises the respective element or combination of elements of a respective one of the compared paths.

A known technique for reducing computational complexity of searches in general is to perform an approximate search, which is a search that is not guaranteed to find the best solution but can trade off computational complexity against accuracy. The disclosed method provides an approximate search that has a good tradeoff between computational complexity and accuracy. To prepare for the search, the input data is broken down into a sequence of smaller elements (e.g. words), and a respective tree search is performed in parallel for each of multiple individual points in the sequence. E.g. where the portion of input data is a sentence and the elements into which it is divided are words, then a tree search may be performed for each gap between words to explore possible missing word sequences that could be imputed into that gap. For example, the approximate tree search algorithm could be a beam search, which maintains a limited beam of paths which are all at the same depth in the tree. The first search step explores single words that might be imputed, the next search step explores pairs of words to impute that include some of the words form the first step, the third search step explores groups of three words that include some of the pairs from the second search step, and so forth if exploring beyond three steps. For example see FIG. 5, to be discussed in more detail later. To prune the paths at each step, the probability scores are compared across all the trees together as a whole, i.e. treating all the trees together as a single beam. This technique advantageously allows the possibility of missing (or erroneous) words at multiple points in the sentence or sequence to be explored, but at the same time keeping the search space small enough that the computational complexity of the search remains at a manageable level.

In embodiments the scores may be estimates of the log-probability of a candidate, given evidence from the original sentence. Alternatively other representations of probability may be used, e.g. a linear probability between 0 and 1. Log probabilities may be preferred since the scores add rather than multiply, which is more efficient computationally. However this is not essential to achieve the efficiency of the approximate search per se.

The outputting may comprise outputting the result(s) to a user. The method may be implemented on a server and the outputting to the user may comprise serving the result(s) from the server to the user device to be output through a user interface of the user device. Alternatively the method may be implemented on a user device and the outputting to the user may comprise outputting the result(s) to the user through the user interface of the user device.

The selection may comprise a single result. The outputting may comprise outputting the portion of data with the respective element or combination of elements of the single selected result substituted at the point of the missing or erroneous data. Alternatively the outputting may comprise outputting a selection of results for the user to peruse, e.g. enabling the user to choose one of the output results to substitute at the point of the missing or erroneous data.

In embodiments, in each successive search step for each point, the set of one or more preceding paths to extend may be selected from the immediately preceding search step.

In embodiments the method may comprise: following each of one, some or all of said search steps for each point, pruning away lower scoring ones of the paths based on the probability scores, thus leaving only one or some of the paths remaining; wherein for each of said plurality of points, in each of the successive search steps, said set of preceding paths to be expended are the paths remaining after any pruning.

The pruning may comprise pruning away the paths having below a threshold value of said probability score. Alternatively the pruning may comprise keeping only a top scoring portion of the paths, such as the top N scoring paths or top scoring Pth percentile where N or P is a predetermined limit, i.e. limiting to a maximum beam width.

In embodiments, each successive search step may not proceed for any of the points until the immediately preceding search step has been performed for all of the points.

In embodiments the method may comprise, for each respective one of said points: prior to the first search step, generating a respective embedding for the respective point, the embedding being a vector generated by a second neural network as a function of some or all of the input elements before and/or after the respective point in the sequence, and as a function of the position of the respective point in the sequence; wherein in the first search step for each of said points, the candidate elements of the respective one or more paths are generated based on a decoder state that is a function of the respective embedding.

The embeddings advantageously provide useful context which helps to guide the search, in the sense of reducing the search space and hence computational complexity, or helping to generate more accurate results, or both. Most approximate searches (e.g. beam searches) can be tuned to trade off accuracy against computational complexity; but providing these embeddings as input guides the search and therefore enables a much better trade-off.

So depending on configuration (e.g. beam width) the designer could choose an implementation designed for speed or accuracy or a desired balance between the two.

In embodiments the method may further comprise, for each of said points: between each successive subsequent search step and the preceding search step, at least for each of the selected set of preceding paths, updating the decoder state as a function of the candidate elements in the respective preceding path; wherein in each of the subsequent search steps, for each of the extended paths, the additional element of the respective path may be generated based on the updated decoder state for the respective path.

In embodiments, for each of said points, the probability score generated by the first neural network for each path in the first search step may also be a function of an initial classifier for the respective position, the classifier representing a probability that the respective point has a missing or erroneous element. In embodiments the classifier may be generated by a third neural network as a function of some or all of the input elements before and/or after the respective point in the sequence, and as a function of the position of the respective point in the sequence. In embodiments the classifier may be generated by a third neural network as a function of the respective embedding.

The classifier advantageously provides context to initialize the search. This again may be used to reduce the search space and hence computational complexity, or helping to generate more accurate results, or both.

The comparison between paths at the end of the process is dependent on the associated scores generated by the first neural network. The comparison could be a direct comparison between the scores determined by the first neural network. However, alternately the comparison may only be indirectly dependent on those scores.

In a preferred embodiment, the method may comprise: following each of some or all of the search steps, skimming off the element or combination of elements from each of some or all of the paths generated from across some or all of the points in the sequence into a candidate pool, the element or combination of elements from each of the skimmed-off paths forming a respective candidate result in the candidate pool; and applying a fourth neural network to each entry to generate a new probability score for each candidate result in the candidate pool; wherein said comparing may comprise comparing the new probability scores in the candidate pool, and said selection comprises a selection of one or more of the candidate results having the highest of the new probability scores.

The use of a separate neural network for the final selection is advantageous since, whilst the first neural network has been trained to be optimized for generating the probability scores for the purposes of pruning, i.e. to eliminate the most unlikely candidates, this does not necessarily mean it is optimized for the purposes of the final comparison, i.e. to identify the most probable candidate result or results. In fact the inventors have identified that a neural network optimized for pruning away unlikely results may in fact have an undue bias when it comes to selecting the most likely candidates. Hence in embodiments a separate neural network is trained for the final selection from amongst the candidate pool.

The final selection of highest scoring candidate result(s) may comprise keeping only the single best scoring result according to the new score, or only those having greater than a threshold value of the new probability score, or only a top scoring portion according to the new score such as the top J scoring candidates or top scoring Rth percentile where J or R is a predetermined limit. Where only the single best result is selected, this may be automatically substituted into the portion of data at the relevant point for output to the user. Alternatively where multiple highest scoring results are selected, these may be output to the user for the user to peruse, e.g. enabling the user to make a selection of which to substitute into the portion of data. In the latter case, optionally the final scores may also be output to the user in association with the respective candidate results to assist the user in the selection.

The dependency on the probability scores generated in the search by the first neural network may simply be the fact that the pruning was based on these scores, i.e. the candidate pool was populated only by those candidate results that survived the pruning based on the probability scores from the first neural network.

Alternatively, said skimming may comprise, for each current one of the search steps, after the current search step is completed across all the points in the sequence, skimming off the element or combination of elements from each of only a selected subset of the paths generated in the current search step into the candidate pool as candidate results, wherein the subset is selected as those paths having greater than a threshold probability score, or those in a highest portion according to the probability score. In embodiments the selected subset may be selected only from amongst the paths remaining after the pruning in the current search step.

Thus the candidate results that are skimmed off (shortlisted) to the candidate pool for re-scoring may be those having greater than a threshold value of the original score, or a top scoring portion according to the original score such as the top scoring K or top Qth percentile where K or Q is a predetermined limit.

In general, the threshold or limit for skimming off may be the same or different than the threshold or limit for pruning. The threshold or limit for skimming off may be the same or different than that use for the final selection. The threshold used for the final selection may be different than or the same as that used for the pruning.

It will be appreciated that “first”, “second”, “third” and “fourth” used in relation to the neural networks are just arbitrary labels.

Where the first, second, third and/or fourth network is a function of at least some of the elements before and/or after the respective point, in embodiments this may mean: at least some of those before or at least some after, or at least some before and at least some after, or every one of the elements before and at least some after, or every one of the elements after and at least some of those before, or every one of the elements before and after.

The neural networks are pre-trained, each to be optimized for their respective function (the first neural network for pruning away low probability candidates, the second for generating embeddings to provide context to guide the search, the third neural network for generating classifiers to initialize the scores, and the fourth for selecting the most probable from the remaining candidates). In the case where the input data represents a natural language, e.g. a portion of text, the trained neural networks thus form neural-network-based language models each having a different roll or sub-function for use in the search. In embodiments one, more or all of these neural networks may be trained using a supervised approach whereby a training data set comprising example input data points and predetermined desired output data points. Alternatively a reinforcement approach or unsupervised approach are not excluded for any or all of these neural networks.

In embodiments, some or all of the first, second, third or fourth neural networks are subgraphs of the same wider network, and are trained together.

The result which the neural networks are trained to optimize is to select an imputation (i.e. the selected candidate element or elements) which when substituted into the portion of input data (e.g. input sentence), will result in an updated version of the input data portion (e.g. sentence) most likely to be correct. In the case where the input data portion was composed by a user, this may mean most likely to represent the intention of the user. And/or, in the case of a portion of input data comprising content of a natural language, e.g. a sentence or other such portion of text, the likelihood may reflect the likelihood of being grammatically or semantically correct. In general, the probability simply represents the whether this is a likely sentence or sequence.

In embodiments the method may comprise, for each of said points: prior to the first search step, including an end-of-sequence element in the input sequence at the end of the sequence to represent the end of the portion of input data, and/or including a start-of-sequence element in the input sequence at the start of the sequence to represent the start of the portion of input data; wherein the input elements of which the first, second, third and/or fourth neural network may be a function include the end-of-sequence element and/or the start-of-sequence element.

In embodiments, in one, some or all of the search steps for each of some or all of the points, the generating of the paths may comprise generating a respective set of multiple paths for each respective one of at least some said points, the multiple paths for the respective point each comprising a different candidate element and associated probability score based on the first neural network.

In embodiments, amongst the multiple paths for each respective point having multiple paths in the current search step, the candidate elements for one of the paths may include a rejoin-sequence element representing stopping the search for the respective point and rejoining the candidate element or elements from the preceding search steps to the input sequence.

In embodiments the portion of input data may comprise a portion of text, and the elements from the received text are words or characters. Alternatively the method may be used to impute missing or erroneous elements in other kinds of discrete data, e.g. in any kind of discrete time series, or in discrete graphical data (e.g. pixels).

In embodiments said points may be gaps between the input elements where missing data is potentially to be imputed. In such embodiments the candidate elements are candidates for replacing the missing data, e.g. missing words.

Alternatively the points may be ones of the elements that are potentially erroneous, in which case the candidate elements are candidates to correct the erroneous data. In such cases, the first, second, third and/or fourth neural nets may also be a function of the potentially erroneously element itself as well. In some such embodiments a separate scoring function (which could be a neural network, or any other function) may be used to score the erroneous element, wherein this separate scoring function depends on the erroneous element and returns scores for candidate words. In this case, the scores of the first neural network and error scoring function may be combined (e.g. by addition) in order to give the scores upon which the pruning, skimming and/or final selection are based.

In embodiments the elements are tokens selected from a discrete set.

In embodiments the first neural network may comprise a unidirectional neural network.

In embodiments the second neural network comprises a bidirectional recurrent neural network.

In embodiments the third neural network may comprise a multilayer perceptron.

In embodiments the decoder state may comprise a hidden state of a hidden state function.

Alternatively it is not excluded that other kinds of neural-net based language models could be used, e.g. a convolutional neural network. Different options for suitable neural networks for use as language models are in themselves known in the art. Regarding the fourth neural network, neural net based language models for scoring probabilities of a data series such as sentences are, in themselves, known to a person skilled in the art. E.g. this could again comprise a recurrent neural network or convolutional neural network.

In embodiments, the outputting may comprise outputting the portion of data with the selected element or elements substituted into it as part of a real-time text-based communication session such as an IM chat session. Alternatively the method could be used in other applications such as email, word processing, online collaboration tools, etc.

According to a second aspect disclosed herein, there may be provided a computer-implemented method comprising automatically:

dividing a portion of input data into a sequence of smaller input elements;

identifying a plurality of points in the sequence at which missing or erroneous data is potentially to be imputed;

in a first search step:
generating a respective set of one or more paths for each respective one of said points, wherein each path comprises a candidate element to potentially replace the missing or erroneous data at the respective point, and an associated probability score, the probability score being generated by a first neural network as a function of some or all of the input elements before and/or after the respective point in the sequence, and
pruning away lower scoring ones of the paths based on the probability scores, thus leaving only some remaining paths;

in each of a plurality of subsequent successive search steps:
generating a respective set of one or more extended paths for each respective one of the remaining paths from the preceding search step, each extended path comprising the candidate element or elements from the preceding search step combined with an additional candidate element, and an associated probability score for the combination, this probability score being generated by the first neural network as a function of some or all of the input elements before and/or after the respective point in the sequence, and as a function of the preceding score for the path from which the extended path was extended, and
with the optional exception of the last search step, pruning away lower scoring ones of the extended paths based on the probability scores, thus again leaving only some remaining paths; and performing a comparison of at least some of the paths including comparing between paths from different ones of the search steps, and based thereon outputting a selection of one or more results wherein each result comprises the respective element or combination of elements of a respective one of the compared paths.

This second aspect corresponds to an embodiment of the first aspect wherein the search is specifically implemented in the form of a beam search.

In embodiments this method may further comprise steps or features in accordance with any of the embodiments disclosed above or elsewhere herein.

Note however the search is not limited to a beam search and can more generally comprise exploring a tree of paths from each of multiple start points in parallel, with any form of sort of parallel tree search.

For instance, the search steps for the different points in the sequence do not necessarily all need to be performed at the same time per step (i.e. the method doesn't necessarily have to generate the paths of the first search step across all points before moving to the second search step for any of the points, and similarly from the second to the third search steps, etc.). Further, the pruning need not necessarily be performed per step at every step (it could be or instead it could be done all at the end, or only at some steps for some paths or points in the sequence). Further, though preferred to help reduce computational complexity, pruning is not essential in all possible embodiments. Instead the method could retain all paths until after the last search step and then sort according to score, or re-score and then sort according to the re-scored probability scores. The one or more highest scoring candidates from the top of the scored list may then be taken as those to output to the user.

According to another aspect disclosed herein, there is provided a computer program product comprising code embodied on computer-readable storage and configured so as when run on a computing apparatus to perform any of the methods disclosed herein.

According to another aspect there is provided a computer apparatus programmed to perform the method according to any embodiment disclosed herein. In embodiments the computer apparatus is a server arranged to provide the element or elements of the selected result to a client application on a client device via a network as part of a service provided to the client device. This may comprise returning just the selected element or elements to the client for substituting into the portion of data at the client application. Alternatively the server itself may perform the substitution and return to the client application the whole portion (whole result) including the substituted element or elements.

### BRIEF DESCRIPTION OF THE DRAWINGS

To assist understanding of embodiments disclosed herein and to show how such embodiments may be put into effect, reference is made, by way of example only, to the accompanying drawings in which:

FIG. 1 is a schematic block diagram of a communication system,

FIG. 2 is a schematic illustration of a neural network,

FIG. 3 schematically illustrates input data divided into tokens with embeddings,

FIG. 4 is a schematic illustration of applying a bidirectional recurrent neural network,

FIG. 5 is a schematic illustration of a search process, and

FIG. 6 is a schematic illustration of a training process.

### DETAILED DESCRIPTION OF EMBODIMENTS

The present disclosure relates to the art of imputation such as word imputation, which is the task of inserting one or more words in a sequence of text. Word imputation for multiple missing words requires an efficient search method, as exhaustive search is prohibitively slow. To address this the presently disclosed techniques use a deep-learning guided beam search to simultaneously explore possible paths for extending the sentence with possible candidate words at each of multiple points in the original sequence, e.g. the points between each pair of adjacent words. To continue the beam (i.e. to explore the paths from each point) a neural net based decoder is used to decode imputed words at each given position (i.e. to assign probability scores to each path, based upon which the paths are pruned to discard unlikely candidates).

Embodiments also use a neural network to generate an embedding for each point based on the position of the point and the words or elements before and after the point, in order to provide context to guide the search. For example this may comprise training a bidirectional recurrent neural network (RNN) over the original text to generate a “positional embedding” for each word boundary in the sequence, and a unidirectional decoder RNN for decoding imputed words at a given position.

Further embodiments also employ one or both of two additional techniques to make this search more efficient. Firstly, a classifier is trained from the positional embedding to determine where the imputed words should be inserted. Secondly, a special “continuation embedding” is inserted at each point, which is also derived from the positional embedding, and is used to predict a finished candidate.

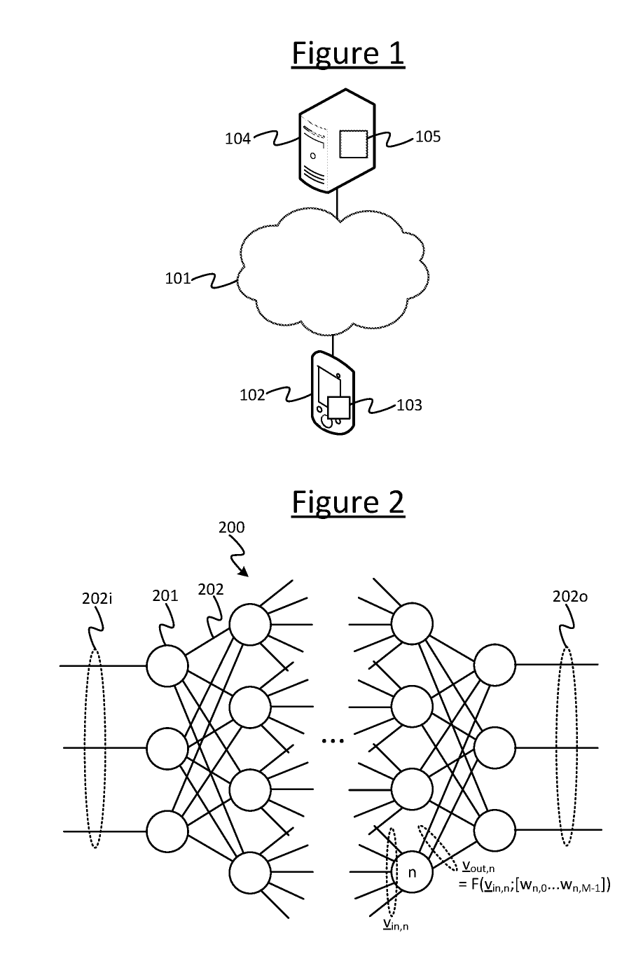

These aspects will be discussed in more detail shortly. First however, some example scenarios in which the disclosed techniques may be employed are described with reference to FIG. 1.

FIG. 1 illustrates an example communication system for serving an imputation service to a client application on a client device. This may be as a stand-alone service but more likely part of another service such as an IM messaging service, email service, word processing service, online collaborative workspace, etc.

The system comprises a packet-switched network 101, a server 104, and a client device in the form of a user terminal 102. The network may comprise a wired network, wireless network or any combination of two or more wired and/or wireless constituent networks. For instance the network may comprise a wide area internetwork such as that commonly referred to as the Internet. In other alternative or additional examples the network 101 may comprise a mobile cellular network such as a 3GPP network, or a private intranet within an organization such as a company (e.g. comprising a wired Ethernet network). The user terminal 102 and server 104 are each connected to the network 101 via a respective network interface, which may take any of a variety of wired or wireless forms. For instance the user terminal 102 may connect to the network 101 via a wireless interface wireless router or wireless area network, using a wireless technology such as Wi-Fi or 6lowPAN. Or the user terminal 102 may connect to the network 101 via a wired interface such as a wired modem and PSTN line, or a wired network card and wired local area network (e.g. Ethernet network). The server may for example be connected to the network 101 via a wired modem and optionally via a storage area network in a respective data centre. It will be appreciated that these options are not limiting and various means for connecting a server and user terminal via various types of network will be familiar to a person skilled in the art. Note also that a server as referred to herein means a logical entity that may be implemented in one or more physical units at one or more geographic sites. Techniques for distributed storage and computing are also known in the art.

The server 104 is arranged to host a serving application 105 and thereby provide a service to a client application 103 arranged to run on the user terminal 102 (the service being provided via the network 101 and the respective interfaces to the network). The service comprises an imputation service, provided by an imputation function of the serving application 105, for imputing one or more missing or erroneous words or elements in a sequence of text (e.g. sentence) or other such sequence of data input. The input data may be composed by a user of the user terminal 102 through the client application 103 and submitted therefrom to the serving application 105 on the server 104 via the network 101 (and respective network interfaces). The imputation function of the serving application 105 then processes the input data to impute one or more missing words or elements in the received data, and substitutes the imputed word(s) or element(s) into the original data to create an updated version thereof. The serving application 105 may then return the updated version of the data (e.g. updated text or sentence) back to the client application 103 on the user terminal 102 for consumption by the user through the user terminal 102 (the returned data again being sent via the network 101 and respective network interfaces).

An example application may be a text-based communication service such as an IM messaging service, email service or online collaborative workspace. Using the client application 103, the user of the (near-end) user terminal 102 composes a portion of text to send to one or more other users of one or more other, far-end user terminals (not shown). The text is sent from the client 103 to the serving application 105 on the server 104, which may generate a proposed correction which is sent back to the near-end client 103 for the near-end user to approve. If the near-end user approves this through his/her client application 103, the client 103 or sever 104 then forwards the updated version of the text to the far-end user terminals in place of the original text.

The imputation function of the serving application 105 comprises at least one pre-trained artificial neural network, for scoring the respective probabilities of possible candidate words or elements to potentially insert into the input text or data. Note that where a neural network is referred to herein, it will be taken as read that this refers to an artificial neural network, as opposed to a naturally occurring biological neural network. In the case where the input data comprises a sentence of text or other natural language content, then the (or each) neural network forms a language model for directly or indirectly determining a likelihood that the content was intended by the composer or that it is grammatical or semantically correct. The imputation function further comprises a search function for searching for possible candidates to score through the neural network. The search is a non-exhaustive search in order to keep the computational complexity of scoring the candidates to a manageable level. Embodiments discussed below are concerned with how to implement this search, i.e. how to determine which candidates to trial.

The neural network or networks is/are pre-trained prior to actual live use. Techniques for training neural networks to achieve some desired outcome, such as to determine probability scores for imputed words, are in themselves known in the art, e.g. by means of back-propagation. The training may be performed at the server 104, e.g. based on a training data set comprising predetermined data sequences and predetermined respective scores. For instance in the case of a language model, the training data may comprise predetermined sentences or other such text sequences along with predetermined scores rating how likely they are to have been intended or to be grammatical or semantically correct, e.g. these scores having been provided by one or more human trainers. In some embodiments the server 104 may also be configured to apply further dynamic training “in the field”, i.e. actual users of various instances of the client application 103 give feedback on the returned results, which can be used to further refine the training of the neural network based model. E.g. such dynamic feedback may be returned through the user terminal 102 and client application 103 to the server 104 via the network 101 and respective network interfaces.

In variants of the system shown in FIG. 1, the imputation function may be implemented in the client application 103. In such cases the neural network(s) may still be trained at the server 104 and the trained model is then downloaded to the user terminal 102 in order to by employed there in the imputation function of the client 103. In other variants, the imputation function is implemented in the serving application 105 at the server 104, but the result of the imputation is not necessarily delivered to the same user, user terminal and client application that composed the input data. An example could be a text-based communication service such as an IM messaging service. In some cases, the input text may be input by a far-end user using an instance of the client 103 on a far-end user terminal (not shown), and sent to the serving application 105 on the server 104 via the internet. The serving application 105 may act as a relay to forward the text, but also automatically substituting the imputed word(s) or element(s) into the text before forwarding the updated version to the near-end client 103 on the near-end user terminal 102 for consumption by the near-end user.

Each of the serving application 105 and client application 103 take the form of software stored on computer-readable storage of the server 104 and client device 102 respectively, and arranged to run on a processing apparatus of the respective computing apparatus 104, 102. The storage takes the form of one or more memory units employing one or more memory media, e.g. electronic memory such as a solid state drive, or magnetic storage such as a hard disk, or even other forms such as optical memory. The processing apparatus takes the form or one or more processing units, e.g. central processing units (CPUs) or work accelerator co-processors such as GPUs (graphics processing units). The specific choice of hardware is not limited and various suitable storage and processing equipment will be familiar to a person skilled in the art. Also note again that in some implementations the server 104 may in fact represent multiple physical server units distributed across more than one location.

FIG. 2 schematically illustrates the idea of a neural network 200, instances of which be employed for one or more of the functions disclosed herein.

The neural network 200 takes the form of a graph comprising a plurality of nodes 201 and a plurality of vertices 202, all implemented in software stored on computer-readable storage of the relevant computer apparatus and arranged to run on one or more processing units of that computing apparatus (server 104 or client device 102 as discussed previously). Each node 201 has one or more inputs and one or more outputs. At least some of the nodes 201 each have multiple inputs and at least some of the nodes 201 each have multiple outputs. Each of the vertices represents a connection into one of the nodes 201, out of one of the nodes 201 or between a pair of the nodes 201. Some of the vertices connect between inputs and outputs of different nodes 201 in the interior of the graph, with at least some of the nodes 201 having multiple outputs connected via respective vertices 202 to inputs of multiple other nodes 201, and at least some of the nodes 201 having multiple inputs connected via respective vertices 202 to the outputs of multiple other nodes 201. The vertices 202 into some of the inputs of some of the nodes 201 form the input 202i to the graph as a whole, i.e. forming an input vector. The vertices 202 from one or more of the outputs of one or more of the nodes 201 form the output 202o of the graph as a whole. This output 202o could be a vector or could be a single scalar value (e.g. in the case of outputting a scalar probability score).

Each node 201 represents a respective function of its inputs as received at its input vertex or vertices 202, the result of the respective function being expressed at its outputs and passed on via the respective output vertices 202 (on to the input(s) of the next node(s) 201 in the graph or the output of the graph, depending on the position of the node 201 in the topology of the graph). Further, the function of each node 201 is parametrized by a respective one or more parameters w, sometimes also called “weights” (not necessarily implying a multiplicative factor, though this is one possibility in embodiments). For instance one of the nodes 201 is labelled as node n in FIG. 2, having an input vector v_{in,n} formed of the inputs to the node inputs and an output vector v_{out,n} formed of the outputs from the node. The output vector v_{out,n} of node n is a function F of its input vector v_{in,n} and of a respective vector of M parameters [w_{n,0} . . . w_{n,M-1}] (where the number of parameters M, the number of elements in the input vector v_{in,n} and the number of elements in the output vector v_{out,n} may in general be different than one another or the same).

The values of the parameters w of each node 201 are gradually trained based on feedback of the overall output 202o of the graph for each of a range of experience data input to the input 202i of the graph 200. For instance in a supervised approach to training, there is provided a training data set comprising a range of (many) different sample values for the input 202i of the graph, and corresponding predetermined values for the output 2020 of the graph 200 (e.g. as specified by a human trainer). Each input sample (each input data point) comprises an input vector with a respective value for each of the individual input vertices of the graph input 202i. Each corresponding output (each output data point) comprises a scalar or vector depending on whether the output 202o of the graph is a vector or scalar. The output 2020 of the graph is compared with the predetermined output in the training data (representing a desired output for the given input). With each input sample (each input data point), the training algorithm tunes the values of some or all of the parameters w in the graph 200 so as, over many training samples, to attempt to minimize the difference between the actual observed output 202o and the desired output. In effect, the training of the graph is just a very large fitting problem.

Other approaches to training include the reinforcement approach. In the reinforcement approach, the training data does not comprise feedback in the form of a predetermined output which can be compared against the actual observed output 202o. Rather, the feedback per training data input sample comprises feedback as to whether the output 202o gave a desired result, i.e. did the graph give a positive or negative result (analogous to a win or lose, or giving the algorithm a positive negative reward). This reinforcement feedback could be either on a binary basis (yes/no), or a matter of degree (how close or how good/bad was the result). From this the training algorithm can, over many samples of training data, gradually tune the parameters w of the various nodes 201 in the graph 200 so as to attempt to maximise the chance of a positive outcome.

Another example approach is the unsupervised approach. In this case there is no specified feedback provided in the form of training data, and instead the training algorithm is left to infer its own structure from the input experience data.

It will be appreciated that FIG. 2 is only intended to be schematic and the actual topology of the graph may differ. Various topologies for forming neural networks are, in themselves, known in the art, and the scope of the present disclosure is not limited to any one specific topology. Nor is the specific function F of each node 201 critical. In general some neural networks may be designed to be more suitable for certain applications whilst others may be designed as general purpose networks, but in principle any network can be trained to give some best “fit” for a desired output.

The presently disclosed techniques use one or more pre-trained neural networks to impute missing elements into input data sequences. The following will be described in relation to the exemplary application of word imputation, which is the task of inserting one or more missing words in a sequence of text.

Word imputation is a simplification of sentence expansion, and is related to other sequence processing tasks. Consider an example of word imputation for an original input sentence “I am to school today.” One possible imputed sentence might be “I am going to school today.” This is an example of single word imputation. Another possible imputed sentence might be “I am really looking forward to school today.” This is an example of multi word imputation.

One known task that a neural network can be trained to perform is to generate a probability score associated with a possible candidate replacement sentence such as these to represent the probability that the candidate sentence is what was intended by the composing user of the original sentence, or that it is grammatical or semantically correct. This is a form of language model. Note that strictly stated, the model may in fact be blind to grammatical correctness vs. sematic correctness, or generally the reason a sentence is unlikely—rather, it may simply capture whether the sentence is a likely sentence given the training data. Nonetheless, despite the fact that the inner workings of the model itself may be blind to grammar, semantics or intention per se, the effect of the training will tend to be to award low scores to ungrammatical, non-semantic or unintended sentences. In this sense at least, it may be said herein that the probability score represents the probability or likelihood of a sentence or sequence being intended, grammatical and/or semantically correct.

It is then the role of the search function to identify multiple different candidates for the imputed sentence and pass each of these through a language model in the form of a neural network to score each of them. The scores can then be compared to select the most likely candidate.

However, there may be a number of different possible imputations of one or more words at each of any of a number of different points in the sentence. Word imputation for multiple potential missing words therefore requires an efficient search method, as exhaustive search is prohibitively slow. Even imputing two words from a small vocabulary with exhaustive search is likely to be prohibitively slow (e.g. in the case of execution for a single user on a mobile device), or prohibitively expensive (e.g. in the case of execution for multiple users on a server). As the computational complexity of exhaustive search is exponential in number of words to be imputed, this approach rapidly becomes infeasible for longer sequences of imputed words. It would be desirable to more efficiently generate possible word imputations.

Text generation is commonly performed using generative RNNs, using either sampling or a beam search. However, these techniques are not currently readily applicable to word imputation, as the naive unguided search is unable to use any information from the original sentence after the text being imputed.

The present disclosure provides an improved method which performs a simultaneous beam search for missing data from multiple positions in an input sequence. In embodiments the method may also comprise generating a classifier to initialize a beam search path cost across multiple positions in an input sequence, and/or deriving an end-of-sequence classification from reverse (and optionally forward) context. The method may comprise training a model jointly to do sequence decoding, position “start” classification and end-of-sequence classification. The method may be employed to perform missing data prediction in sequence data, such as from sequences of words or characters.

The disclosed method is performed by the imputation function implemented for example in the serving application 105 or client application 103. The imputation function employs one or more pre-trained neural networks 200, e.g. language models in the case of processing natural language content. Each such neural network will be understood to take a form as discussed above in relation to FIG. 2. The imputation function may be implemented in software stored on computer-readable storage (memory such as electronic, magnetic and/or optical memory) and arranged to run on one or more processing units (e.g. CPUs or work accelerator processors).

The method may comprise four basic phases: (i) tokenization (a standard NLP component); (ii) candidate generation; (iii) result scoring (may be unnecessary, depending on candidate generation); and (iv) result delivery and presentation to the user (e.g. serving the results from the server 104 to the client device 102). The techniques disclosed below lie especially in phase (ii). Phases (i), (iii) and (iv) may be implemented using known techniques.

The tokenization at phase (i) refers to automatically dividing up the input data into smaller tokens, being elements selected from a discrete predetermined set. In the case where the input data is an input text string comprising natural language content, e.g. a sentence, then the tokenization may comprise segmenting the text string into individual words. Tokenization in itself is a standard natural language processing (NLP) task, varying in complexity depending on the language used. The techniques disclosed below work with any word tokenization procedure.

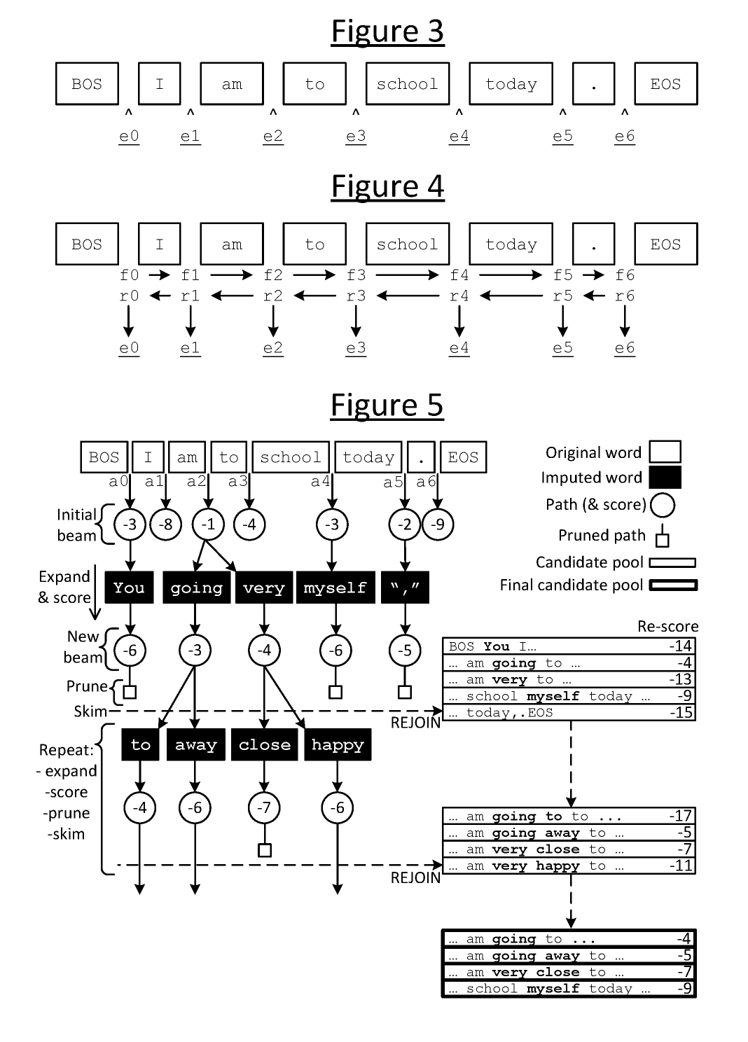

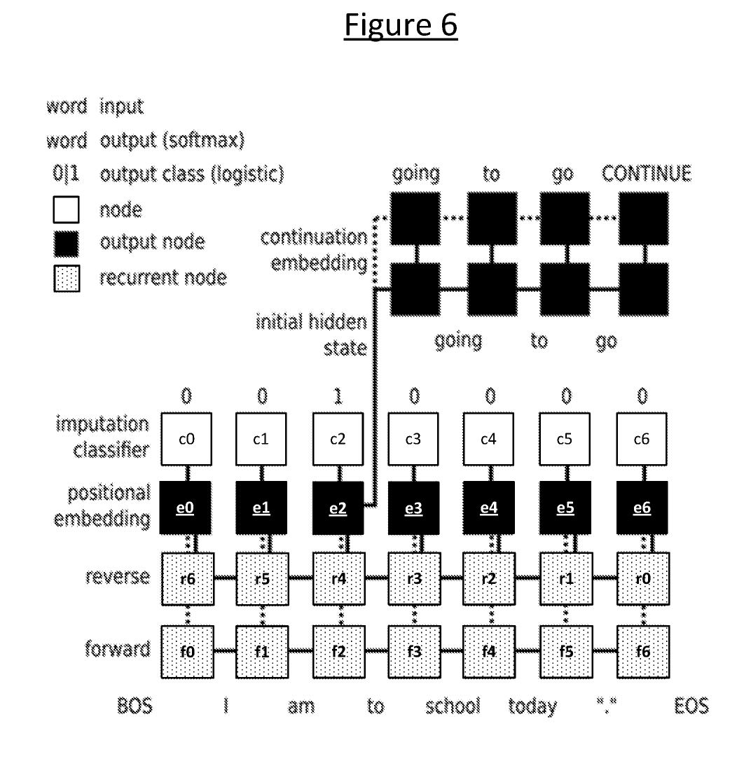

Taking the example input sentence “I am to school today.”, the tokenization may comprise dividing this into a sequence of tokens “I”, “am”, “to”, “school”, “today” and “.” The tokens or elements have an order in the tokenized sequence which is the same as the order in the original input data. In embodiments, the method further comprises adding additional tokens to the sequence at the start and end of the sequence, in the form a “beginning of sequence” symbol (BOS) and “end of sequence” symbol (EOS) respectively. So in the given example, the input sequence to be processed in the next phases in fact becomes: BOS, “I”, “am”, “to”, “school”, “today”, “.”, EOS, in that order. See FIG. 3.

The candidate generation at phase (ii) refers to generating candidate versions of the sequence (e.g. sentence) with potential missing words imputed. In the present disclosure, this involves generating candidates that have words imputed at different points in the sequence, and for each potential point there may be candidates with one or more missing words imputed. For each of one or more of the points where words may potentially be imputed, there may be multiple candidate imputations generated in different respective versions of the sentence. For at least one such point, preferably there are different candidates generated with at least one candidate having a single imputed word and at least one candidate having multiple imputed missing words.

So in the example, the candidate sentences may include for instance: “I am going to school today”, “I am looking forward to school today”, “I am to school myself today”, etc.

Embodiments of the candidate generation process of phase (ii) will be discussed in more detail shortly.

Phase (iii) is result scoring, i.e. scoring the candidates generated from phase (ii). After any process of generating candidate sentences, these candidate sentences may be rescored using a simple language model. Language models for scoring the probability of a candidate sentence are in themselves known in the art. This language model may for example be implemented in the form of a neural network as discussed in relation to FIG. 2.

In embodiments, the score for each candidate sentence may be generated by computing the following sum:

sum_i[log p(w_i|w_{<1})]

where p is a function in the form of a neural network which outputs a respective probability value for word w{i} as a function of word w{i} and the preceding words w{<i}, where the index i represents the position of the word in the sentence. This reduces the problem of scoring a sequence to scoring a single element from the sequence given preceding elements (this is a standard procedure in language modelling). Note that for a forward sequence decomposition such as this, the scoring model should preferably also score a sequence termination symbol EOS which is appended to the sequence to be scored.

Phase (iv) is the delivery and presentation of the result to the user. If the method is run on a server 104, this may include sending the results over the network 101 to the client device 103, which may be done using standard protocols (such as JSON over TCP). In any case, the result is presented to a user in some way. This may for example comprise automatic insertion of imputed words from the top result. I.e. the scores for the different candidate sentences from phase (iii) are compared, and the highest scoring candidate based on this comparison is then selected (e.g. the candidate having the highest value of sum_i in the above equation). This best scoring sentence is then used to automatically substitute the original sentence. Another possibility is to provide multiple results, which may for example be the best scoring top Rth percentile of results from phase (iii), the best scoring K results, or those results having greater than a threshold score. The multiple results may be output as a simple list of results, or in an interactive interface which allows the user to explore one or more imputation results. Either way, the user may then select one of the multiple presented candidate sentences to use in place of the original sentence.

Some of these result presentations may require “reverse tokenization”, which is typically simpler than tokenization. This procedure joins a tokenized sequence of words to a single text string.

The candidate generation of phase (ii) is now discussed in more detail.

### Overview

Embodiments use a specially trained neural network to implement a guided beam search across multiple positions of an input sequence, including to generate multi-word imputation candidates for at least some of the points.

Examples herein may refer to the input sequence as a sentence, though the techniques are not limited to a complete single sentence, and more generally the teachings herein can be applied to any sequence of text comprising natural language content. The following will also be exemplified in terms of missing word imputation, so each point at which a word is potentially to be imputed comprises a gap between words (or tokens) where a missing word may potentially be inserted. However, another possibility is correcting an existing word, in which case the points are the positions of the words in the sequence rather than the gaps between words.

The following will continue to refer to the example input sequence “I am to school today.” (Which might generate imputed results such as “I am going to school today.”, “I am going to go to school today.”, etc.).

The search function comprises a decoder for generating candidate words to potentially be imputed into the sequence, and at least a first scoring function for scoring these candidates. These may be implemented in the form of a neural network. In embodiments the decoder and the first scoring function are the same function, and may be implemented as the same network. Alternatively they may be split.

Referring to FIG. 5 (to be discussed again in more detail later), a search is performed simultaneously for each of multiple points in the input sequence, e.g. the points between different pairs of words (or tokens) in an input sequence of three or more words such as a sentence. For each of multiple points in the sentence (e.g. each of some or all of the gaps between words), the search comprises a respective tree search comprising multiple steps. That is, for each such point, one or more first candidate words are generated by the decoder. Each of these is a candidate for the insertion of a single word at the respective point. So for example between the words “am” and “to” in the input sequence, at least two alternative possible missing words “going” and “very” may be generated. Each of these may be described as an alternate “path” in the language of beam or tree searches. This is done across multiple points in the sequence, so each point spawns a respective one or more paths, with at least one or some of the points spawning multiple paths (a tree). Across all the paths from all the points and all branches of the trees, the paths together may be described as a beam. The candidate word for each of these paths in the beam is scored by the first scoring function, which may be implemented in the form of a first pre-trained neural network. The lowest scoring paths according to this score are then pruned away. This may comprise keeping only those with above a threshold (i.e. pruning away those below a threshold), or keeping only those in an upper portion such as only the top N scoring paths or the paths in the top Pth percentile according to the score (pruning away those below this number).

Then in the next search step, the remaining paths are expanded. This means for each remaining path, one or more second candidate words are generated by the decoder. Each of these is a candidate to add to the respective first word as a possibility for the insertion of a pair of words at the respective point in the sequence. For one or some points, there may be multiple different alternate candidate second words to add to the respective first word, i.e. further branches to the tree. So for example for the point between the words “am” and “to” in the input sequence, the candidate first word “going” from the first search step may spawn at least two possible word pairs “going to” and “going away”, and the candidate first word “very” from the first search step may spawn at least two possible word pairs “very close” and “very happy”. These extended paths (word pairs) are then scored by the first scoring function, and the lower scoring paths are again pruned away, similarly to the first search step. The threshold or limit for pruning may be the same or different at each step.

This process may continue over one or more further search steps, so as to generate candidates for the insertion of three words at one or more of the points in the sequence, or perhaps even four words, etc. E.g. continuing the above example, the pair of words “going to” from the second search step spawns “going to go” in the third search step and then “going to go to” in the fourth search step. The word pair “going away” from the second search step spawns “going away to” in the third search step, etc.

In embodiments, the generation of the candidates by the decoder is essentially done by scoring. This may comprise for each point in the sequence, generating a set of preliminary candidates, then comparing the preliminary candidates within the set generated for the same point in the sequence, in order to immediately eliminate all but the most likely top scoring of these (e.g. top S or top Tth percentile) to retain as candidates to compare amongst the candidates from across the different points in the sequence (wherein the scores used for both comparisons may be the same scores). In variants, there need not even be any separate step of initially pruning away preliminary candidates per point. Rather, the pruning may simply be applied in one go across the beam width for the multiple points in the sequence at once, e.g. pruning all but the top N scoring results or top Pth percentile from across all points taken together. In embodiments, for each point the decoder exhaustively generates every word in the vocabulary with some score which depends on the context, and then keeps the top N or top Pth percentile, or top S or top Tth percentile per point (where S or T could be the same as or P or different). As it is known the beam width is going to be limited anyway, nothing useful is lost by limiting to the same width immediately.

At each search step, the next candidate words (or tokens) generated by the decoder are a function of the words either side of the respective point in the sentence, and any candidate word or words from preceding steps in the path. In embodiments, each candidate word is function of a respective “positional embedding” generated for each respective point in the sequence or sentence. The positional embedding e is a vector that is a function of the position of the point in the sequence, and some or all of the words either side of that point in the sequence (see FIGS. 3 and 4, to be discussed further shortly). The positional embedding may be generated by a second pre-trained neural network. This embedding provides context to aid the decoder in the generation of each candidate word at each successive search step.

At each search step, the updated probability score generated by the first scoring function is a function of the preceding score in the path. In embodiments the score at the first step is a function of an initial score for the respective point in the sentence or sequence. The initial score may take the form of a classifier representing the probability that there is a word missing at the respective point. The classifier for each point is generated by a classification function, which may be implemented in the form of a third pre-trained neural network. Note also that in embodiments, paths from some possible points in the sequence are ruled out or pruned away before even the first search step, on the basis of having a low initial classifier (low initial score). E.g. it is unlikely there is a word to be imputed between “I” and “am”, or between “.” and EOS.

At each search step, the method may also comprise skimming off (i.e. shortlisting) some of the results from a selected subset of the paths into a candidate pool. The results in the candidate pool may be re-scored by a re-scoring function. This may be implemented in the form of a fourth pre-trained neural network. The skimmed-off results may be those having a probability score greater than a certain threshold, or those with the top J scores or in the top Qth percentile. The inventors have found that the use of a separate neural net based language model to re-score the shortlisted candidate results at this stage is advantageous, because the first scoring function can tend to be biased. While the first search function is trained to enable pruning away the least likely results, this does not necessarily lead it to be optimized for selecting the most likely final result(s) from amongst the shortlist.

The re-scored results in the final candidate pool, after all the search steps, are then compared with one another in order to select at least one final result having the highest rescored score. This could comprise selecting the single candidate with the highest (new) score. Alternatively it could comprise selecting a top scoring portion of multiple results according to the rescored scores, e.g. the top K results or top Rth percentile. The multiple final selected results may then be presented to the user to enable the user to select a desired one of these.

The first, second, third and fourth neural networks, and the decoder, and any other functions implemented as neural networks are preferably all subgraphs of the same wider neural network (i.e. there are connections therebetween and they are trained together). Alternatively some or all of them could be separate neural networks. The main reason to make them subgraphs of the same network is to share computation—i.e. to avoid computing basic shared features of the input multiple times. However this not essential.

### Positional Embeddings

As shown in FIG. 3, in preferred embodiments a “positional embedding” e_i is computed for each gap i between adjacent words (or tokens) in the input sequence. The positional embedding for each point (each gap) is generated using a pre-trained neural network, preferable a bidirectional recurrent neural network (RNN).

Note that control tokens in the form of beginning-of-sequence (BOS) and end-of-sequence (EOS) tokens are prepended and appended to the sequence, respectively, to indicate the start and end of the sequence. These provide additional information to be taken into account by functions such as the positional embedding which are a function of the tokens before and after a given point in the sequence. They are however optional and reasonable results may be obtained without them.

Each individual positional embedding e is a vector (so e0 is a vector, e1 is another vector, etc.). Any one given individual element of the vector does not in itself represent anything per se. However, as a whole, the vector provides additional context about the respective point in the sequence, to be taken into account by the decoder when generating the candidate words for that point, and thus ultimately helping guide the search.

Particularly, each positional embedding is a function of the position in the sequence and every word in the input sequence. Thus the position embedding provides context, when generating the candidate words for a given point, of where that point lies in the sequence and the words (or tokens) either side of that point (including the BOS and EOS symbols). It will be appreciated that the likely candidate word or words to be generated for a given position in the sentence will depend on this contextual information. The embedding is a vector rather than a scalar in order to represent the multidimensional nature of the problem.

In embodiments the positional embedding may be computed by running a bidirectional network over the input sequence, and concatenating hidden states at each point. This is illustrated in FIG. 4. This method has the advantage of being simple to compute with a single forward and a single reverse scan through the input, providing a positional embedding at every position in the input. In the example shown in FIG. 4, f and r are the two separate component networks of a bidirectional RNN. f represents the hidden states of the forward scan, and r represents the hidden states of the reverse scan. e is simply the concatenation off & r (so e.g. if each off & r have 80 elements, e will have 160 elements). It will be appreciated this is just one example. There are other ways of combining f & r other than concatenation, and these in themselves are known in the art.

These positional embeddings e can be trained to solve multiple tasks. As they only depend on the input sequence, they can be stored for the remainder of the procedure—they never need to be recomputed unless the input changes.

An example of the way in which the generation of candidate words depends on the positional embedding will be described shortly with reference to the decoder.

### Classifier

A classifier is also generated for each gap between words or tokens in the input sequence (including the BOS and EOS tokens). The classifier for each point is used as the starting score for each starting point in the beam search (see again FIG. 5—“initial beam”). It is a scalar, and may be generated in the form of a binary classification to predict the following two classes:

0—there are no words to be imputed at this position,

1—one or more words should be imputed at this position.

The classifier may be a true binary value, i.e. 0 or 1, but more preferably it takes a variable value on a scale between 0 and 1 to represent the degree of likelihood that a word is to be imputed at the respective point. The starting score in the beam search may be then be log of this to give scores that will add rather than multiply at each subsequent step (to reduce computational complexity of propagating successive probability scores, but this is an optional implementation detail).

In embodiments the classifier for each point may be generated used a function from the respective positional embedding. This may for example be a simple and fast function, such as a small multi-layer perceptron from the positional embedding to a scalar representing the class probability p(impute=1|e_i), where i is the position of the respective point in the sequence. E.g. a sigmoid nonlinearity may be used to produce such probability-like classifications. This soft classification probability may be used to initialize the beam search. See the discussion of the beam search below.

### Decoder

The decoder is the function of the search function which generates the candidate words (or tokens) for each path.

Note that in the example implementation, one of the possible tokens the decoder can generate at each search step is not a word per se, but rather another special control token called herein the “rejoin sequence” token (REJOIN). This represents stopping the search along the current path and rejoicing the sequence. So for example, in the second search step in FIG. 5, one of the possible candidate tokens the decoder may generate to add to the word “going” is the REJOIN token, representing the idea that this is the last word in the imputed subsequence and the imputed subsequence now re-joins the rest of the original sequence at “to school today.”

In embodiments the decoder comprises an initial hidden state function h_0 (a neural network which transforms a positional embedding into an appropriate shaped vector for the decoder), and a generative RNN. These define the functions:

h_0=init_fn(e_i)

h_{ti1}=step(h_t,x_t)

y_t=predict(h_t,e_i)

where h_0 is the initial hidden state function and h_{t+1} is the state of the hidden state function at successive search steps t. The generative RNN is the pair of functions (step, predict). N.B., any part of a neural network is also itself a neural network, so just as the generative RNN is a neural network, so are the component parts step & predict. Y_t is a vector of probabilities of next terms—it is the thing actually wanted out of the decoder, whilst h_t is just there to facilitate this. Everything except x is a vector—i.e. all of h_t, e_i, y_t are vectors. x is a scalar discrete label when talking about word imputation.

This is a generative model, as a probability distribution over the next words (y_t) is defined by the prediction function “predict”, given only previous words (and the original hidden state, which is a function of the positional embedding e). Therefore, a word can be sampled or selected from this distribution, then input into the step function “step” to advance to the next state h_{t+1} with each successive search step, repeating this process to generate a sequence of words of arbitrary length.

In embodiments of the present disclosure, this decoder network is extended by using the positional embedding to compute a special “rejoin embedding”. The positional embedding is a general-purpose internal feature of the network (it can be an arbitrary size), which may be for multiple purposes, whereas the continuation embedding is the same size as the decoder's word embeddings and is only used to score the special “REJOIN” token. The continuation embedding may for example be computed using a multi-layer perceptron operating on the positional embedding. This rejoin embedding is unlike standard word embeddings from the vocabulary. Traditional word embeddings are vectors of learned parameters (for example, 256 floating point numbers) which represent the word, and do not depend on any input or context. However, the rejoin embedding is computed dynamically based on the context, using a function (e.g. a neural network) from the positional embedding. In deep learning terminology, it is an activation rather than a parameter. The shape of the rejoin embedding is constrained to be the same shape as the word embeddings. In all other ways, it is treated as a word embedding: it is concatenated onto the matrix used to score words, and the softmax is taken over the result to give the probability of any word, or the special rejoin sequence token (REJOIN):

| ce = rejoin_embedding_fn(e_i) | |
|---|---|
| M = [[--- m_0 ---] # the | |
| [--- m_1 ---] | # you |
| ... | |
| [--- re ---]] | # REJOIN |

y_t = softmax(M * p_t)

i.e.

y_t = [ p(y=“the”), p(y=“you”),... p(y=CONTINUE) ]

where M is a matrix, comprising a stack of V+1 equal-length vectors [m_0 m_{V−1}, rejoin_embedding]. E.g. if V (vocab size)=3, the matrix will contain [m_0, m_1, m_2, re], each of which will be the same size, e.g. 8 elements. In reality it would be more like V=10000, each of 128 elements. Softmax is a standard parameterless function that produces a vector of positive values that sum to 1 (so is used here to produce a valid probability distribution).

Therefore, at each step the decoder predicts the probability of each word coming next and the probability of the end-of-subsequence (REJOIN). This REJOIN prediction is preferably based on the positional embedding, in order to ensure that the words imputed by the decoder fit with the rest of the sequence. For example, consider the following imputation scenarios (note that example b) corresponds to a different input sequence from the example used elsewhere):

a) I am [not?] to school today.

b) I am [not?] unhappy!

c) I am [not going?] to school today.

(where text in square brackets represents imputed words).

In case a) the probability p(?=REJOIN) should be low, as it is unlikely that “I am not” is followed directly by “to school today”—it doesn't make grammatical sense. In case b) the probability p(?=REJOIN) should be higher, as “I am not” may be followed by “unhappy !”. However, the system can only distinguish between these two cases because the rejoin embedding is computed from the following text “to school today” or “unhappy !”. If it was a fixed, pre-trained, embedding (such as that of any other word), the decoder network could not distinguish between cases a) and b).

Therefore, in the original example above, the rejoin embedding helps the network to favour REJOIN in case c), which gives the sentence a higher likelihoodover case b), which does not, even though it must impute additional words to do so.

### Beam Search

A beam search refers to a search that retains multiple paths in parallel. According to the present disclosure, there is provided a beam search which explores all imputation candidates for multiple points in a sentence in parallel, pruning some scored imputation candidates at each step, and retaining others to expand in the next step. At each step the word/words from some of the better scoring paths may also be shortlisted as candidate results for comparison in the final selection step.

In preferred embodiments, with the classifier and decoder combining positional embedding-based initialization and rejoin embedding, a particularly efficient search algorithm can be defined for multi-word imputation.

Some definitions are given here to aid the discussion.
Path: represents a partially decoded candidate. It comprises a position in the input sequence, a subsequence of imputed words and an associated path score, and in embodiments also the rejoin embedding and a hidden state.
   path length: number of imputed words in the path
Beam: a set of paths.
   Beam width: number of paths.
   Beam length: length of every path in the beam (every path must have the same length)
Candidate result: a full sequence containing imputed words, preferably tagged with a score (which may be a re-scored score generated by a further language model).

In an exemplary implementation, the operations performed in the beam search may be as follows:

beam_0 = initialise_beam(input)
beam_{j+1}, candidate_results = advance_beam(beam_j)

The initialise_beam operation precomputes any information needed (including positional embeddings for each position in the input sequence), and starts a path a0, a1, a2, a3, a4, a5, a6, at each position in the input sequence (the gaps between the symbols BOS “I” “am” “to” “school” “today” “.” “EOS” respectively). Refer again to FIG. 5.

Each path (a0 . . . a6) may be initialized as follows:
position: i (index in input sequence)
ce: rejoin_embedding_fn(e_i) (REJOIN embedding for this position)
imputed: [ ] (subsequence of imputed words, start with an empty set)
hidden: init_fn(e_i) (initial decoder state)
score: log(classifier(e_i)) (initial log-probability of path)

Each path is set up to include all information required for decoding and pruning against other paths.

The advance_beam operation takes a beam of length L, and creates a new beam of length L+1, also generating candidate results of length L. It is configured with a beam width limit N. Each path in the beam is used to generate a probability distribution over next tokens (including REJOIN). A candidate result is extracted for each path, adding the REJOIN log-probability to the path score (as every sequence of imputed words must terminate in REJOIN to be a valid candidate result). The new beam is constructed by generating N new paths for each original path, each with an extra imputed word and an updated score and hidden state. If the new beam exceeds the beam width limit after expanding it, only the N paths with the best (highest) scores are retained. More formally, the process may be described as follows.

In a first sub-step, compute next-token predictions from each path: y=predict(hidden, ce).

In a second substep, generate a candidate result from each path: score=path_score+log(p(y=REJOIN)).

In a third sub-step, Expand the beam using the top N word predictions (not including REJOIN) from each path:
imputed=imputed+[word]
score=score+log(p(y=word))
hidden=advance(hidden, word) (note that this computation can be delayed until after sub-step 4, for efficiency).

In a fourth sub-step, restrict the beam, retaining only the N paths with the highest scores.

The beam search first uses initialise_beam to set up the beam, then performs multiple advance_beam operations, generating candidate results at each step. Optionally, the candidates are again sorted (across different candidate result lengths), to limit the number of candidate results that are to be scored by the final scoring phase. This is illustrated in FIG. 5.

### Computational Complexity

Computational cost refers to how much work a computer has to do (e.g. method A might have 2× computational cost compared to method B in some situation). Computational complexity refers to how the cost scales as the input scales. E.g. method A might scale linearly with input size, whereas method B might scale exponentially.

The computational complexity of executing a standard run of this algorithm may be estimated by counting the number of forward/predict operations that must be performed. This may be expressed as follows:

Given:
Input sequence length X
Maximum beam width N
Maximum beam length L
Maximum candidates to score M Complexity:
Positional embeddings: 2*X
Beam initialisation: 3*X (hidden, classification, rejoin embedding—although these operations are faster than the others)
Advancing the beam: 2*L*N
Scoring results: 2*M*(L+X) (worst case: all candidates are maximum length) Total complexity: 5*X+2*L*N+2*M*(L+X)=0(X+NL+ML+MX)

The total computational complexity is linear in input length (X), beam width (N) and maximum imputation length (L). It is also worth noting that there are no input length times maximum imputation length complexities O(XL)—these would limit the scalability of multi-word imputation for long sequences, with many imputed words. Therefore, this method can efficiently compute long imputed word subsequences in long input sequences.

### Training the Model

For final rescoring (which is optional), a standard language model may be used. This may be any language model which is capable of computing p(w) for a sequence of words w.

The main search model, comprising the first, second, third and fourth networks, may be trained jointly using paired data, consisting of an input sequence and a sequence of imputed words at a given position in the input sequence. This paired data can be generated from plain text data by randomly splitting out a contiguous sequence of words to be imputed.

The main search model may be trained by connecting it as it would be run during inference, with two objective functions—the classification objective, and the sequence decoding objective. These objectives are added together to create the single objective needed for optimization using backpropagation. Any optimizer common to neural network training, such as Adam, Adagrad or RMSprop can be used to optimize the objective using minibatch gradient descent, a standard procedure. A diagram showing a simplified example of the training graph is shown in FIG. 5.

### Example Variants

It will be appreciated that the above embodiments have been described by way of example only.

For instance, while the above has been exemplified in terms of imputing missing words, the same techniques can also be used for sentence expansion or correction of existing words. For instance, the same basic idea could be easily extended to the task of subsequence correction. Note that in the context of the present disclosure the term “impute” can also alternatively refer to inferring the intended meaning erroneous data, i.e. imputing corrections onto erroneous data.

Specifically, this task takes as input a sequence of likely tokens (e.g. words), each with a confidence distribution over alternatives, and generates corrected sequences. The process may also employ rejoin embedding and imputation classification as in the described embodiments. In such embodiments, each searched point is the position of a potentially erroneous word in the input sentence or sequence, rather than a point between words where a missing word is potentially to be imputed. Further, where a function or property such as the probability score or the embedding is a function of the words before and/or after the respective point in the sequence, then this may also be a function of the word at the point in question, i.e. the word to potentially be corrected.

Consider an example where the original sentence is “U an gong to school today.” The corrected sentence may for example be “I am going to school today.”

A very similar architecture can be used to perform this task: first positional embeddings are computed (e.g. running a bidirectional RNN over the sequence), and then classification scores are generated for each position. The classifier may be trained to be positive for the first word of a sequence that needs correction, negative for everything else.

The beam search starts a branch at the point of each potential word to be corrected, using the positional embedding for the initial hidden state and the classification score for the initial path score, as per the missing word imputation beam search. To advance the beam, the next word prediction distribution from the model is combined with the input confidence distribution (e.g. adding log-probabilities), and generate candidates in the same way as described in relation to the missing word imputation, i.e. from the combined distribution (scoring a rejoin embedding to generate results, and limiting the beam to generate a new set of paths).

A difference relative to the missing word imputation search may be that the rejoin embedding is not fixed for a path—rather, it depends on the number of words that have been corrected. E.g. if the path starts at position index i=1, and the search has advanced two steps, the rejoin embedding used to generate candidates should be at index (1+2=3). This is because for this task, the “sequence being continued” is reduced by one element every time a new word is corrected (as any inserted corrections consume an item from the input, whereas imputations don't).

In some embodiments of imputing corrections for erroneous data (as opposed to missing data), a separate, additional error scoring function may be used for scoring the potentially erroneous data and/or potential replacements for the erroneous data (e.g. erroneous word word). This separate scoring function could be a neural network, or any other function. Functions for scoring the likelihood of a word or potentially erroneous word are in themselves known in the art. Such a function depends on the erroneous element and in embodiments may be used to return scores for the word and candidate corrected versions of the words. In this case, the scores of the first neural network and the error scoring function are combined (e.g. by addition) at each step in the decoding process in order to give the scores upon which the pruning, skimming and/or final selection is performed.

In further variants, while embodiments above have been exemplified in terms of the input data being a sentence, more generally the input data does not necessarily have to be a complete sentence, or it could even be more than a sentence. Anywhere herein that refers to a sentence could more generally be extended to any portion of text comprising a series of words of a natural language, which could for example be a sentence, a clause or other part of a sentence, or a passage comprising two or more sentences. Also, the method could be used to impute missing letters or other characters, or parts of words, not necessarily just whole words.

Further, word imputation is a special case of missing data prediction, so the disclosed method can further be generalized to any sequence data. For example this could be to impute missing or erroneous samples in any scalar data sequence, e.g. time series data—a scalar value that varies with time, such as an audio signal). Another example would be to impute missing or erroneous elements such as pixels in graphical data (generalized to 2D data for still images, or 3D data for videos). In such cases, the method also does not have to treat the elements of the signal as tokens in the sense of elements selected from a discrete set (like words from a vocabulary), but instead the sequence could be processed in terms of elements that can take any arbitrary, continuously variable value (i.e. the input data samples and the imputed data elements may be continuous scalars). For example, in this case the candidate generation step in the beam search might sample from a continuous distribution described by the decoder, in order to generate a discrete set of paths to process in the search. In general, the methods disclosed herein can be applied to any input data series that is formed from discrete items or that can be divided into discrete elements on the input axis, e.g. discrete-time series, or discrete-space images, etc. The value being predicted for could be discrete or continuous.

The scope of the teachings herein is also not limited to the example types of neural network based language models described above. Other types of neural network suitable for language models will be known to a person skilled in the art. E.g. a convolutional neural network could be used instead of a recurrent neural network. Consider for example the neural network used to generate the positional embeddings. The positional embeddings may be computed by some other function, e.g. convolutional neural network, or recurrent neural network with self-attention. Where a bidirectional network is used, forward and reverse positional embeddings combined by any function e.g. concatenation, summation, multiplication, or a multi-layer perceptron.

Other approaches to training the neural network in the first place may also be used, e.g. reinforcement approach.

Further, properties such as the probability score or positional embedding do not necessarily have to be a function of all the words or elements before and after the respective point in the sequence. For instance the rejoin embedding may be computed using just the words following the respective point in the sequence (not including the preceding words, as with the full positional embedding).

Further, not all embodiments have to use a classifier as an initial probability score of each path. Instead the initial score could be a predetermined value or generated via some other means, or the first scoring function may simply not be a function of an initial score in the case of the first search step. While the classifier assists in generating the probabilities and therefore pruning the paths, and is thus preferred, reasonable results with reasonable computational efficiency can still be achieved without it. Also, even where a classifier is used, this does not necessarily have to be based on same positional embedding as the candidate word generation. Instead the classifier could instead be generated based on a different function, e.g. directly as a function of the position in the sequence and the words or elements before and/or after that point in the sequence.

Furthermore, not all embodiments have to use embeddings such as the positional embeddings. Instead the decoder may for example generate the candidate words on a different basis, e.g. directly as a function of the position and the sequence and/or some or all of the surrounding words or elements before and/or after that point in the sequence. The embeddings provide useful context to guide the search, but are not absolutely essential. Though preferred, reasonable results with reasonable computational efficiency can still be achieved without the embeddings.

In yet further variants, the scope of the present disclosure is not limited to a beam search. A beam search is one example a suitable search, but there are others. More generally any weighted tree or graph search algorithm can be used in place of a beam search, e.g. Dijkstra's algorithm (i.e. the most probable path of any number of imputed words or elements is extended at each step) or an A* algorithm. Where a beam search is used, other variants of a beam search may be used. E.g. the beam search may be based on maximum length, number of candidates, or the maximum score of any path in the beam.

A beam search describes a sequence of steps, wherein in each step the set of paths from the last step is extended by computing one or more extended paths for each path, each containing an additional element. It is the exploration order that makes this a beam search—only paths from the last set may be expanded (in fact in some cases all previous sets are discarded to save memory & computation). N.B. this is why in embodiments the system generates all one-word imputations in the first search step, then all two-word imputations in the second search step, and so on. So it would be impossible to generate a one-word imputation in the sixth search step in a beam search.

More generally however the score of the present disclosure need not be limited to a beam search, and could also extend to parallel searches that explore the candidates in a different order. For example an A* algorithm could “resurrect” a path from a previous step, based on a heuristic function. The present disclosure covers any method of exploring from multiple start points simultaneously with any form of parallel tree search.

In a more general statement of the search process, the first search step may remain mostly the same, except optionally the pruning could more generally be pruning or ordering (for example a priority queue). For the successive search steps, the process comprises: choosing a set of one or more paths to expand (e.g. which in the case of beam search is simply the previous set, or in A* the best paths using a heuristic score); generating extending paths (as before, but not necessarily from the immediately preceding search step, instead from the set of chosen paths to extend); and again pruning or ordering.

N.B. in variant search algorithms the “hard” pruning of beam search is replaced by a “softer” ordering of paths using an efficient data structure such as a priority queue, or repeated sorting.

In summary, in variants the candidates to consider extending are not limited to being the set generated by the preceding step. Also, the pruning may for example optionally be replaced with ordering (sorting), in order to efficiently choose a set of paths to expand.

Other variants may become apparent to a person skilled in the art once given the disclosure herein. The scope of the present disclosure is not limited by the above-described embodiments but only by the accompanying claims.

1. A computer-implemented method comprising automatically:
dividing a portion of input data into a sequence of smaller input elements;
identifying a plurality of points in the sequence at which missing or erroneous data is potentially to be imputed;
for each respective one of said points:
in a first search step, generating a respective set of one or more paths for the respective point, wherein each path comprises a candidate element to potentially replace the missing or erroneous data at the respective point, and an associated probability score, the probability score being generated by a first neural network as a function of some or all of the input elements before and/or after the respective point in the sequence, and
in each of a plurality of subsequent successive search steps, selecting a set of one or more of the preceding paths from one or more of the preceding search steps to extend, the selection being based on the associated probability scores, and generating a respective set of one or more extended paths from each respective one of the selected set of preceding paths, each extended path comprising the candidate element or elements from the respective preceding path combined with an additional candidate element, and an associated probability score for the combination, this probability score being generated by the first neural network as a function of some or all of the input elements before and/or after the respective point in the sequence, and as a function of the probability score for the respective preceding path; and
performing a comparison between at least some of the paths including comparing between paths from different ones of the search steps, and based thereon outputting a selection of one or more results wherein each result comprises the respective element or combination of elements of a respective one of the compared paths.

2. The method of claim 1, wherein in each of the successive search steps for each point, the set of one or more preceding paths to extend is selected from the immediately preceding search step.

3. The method of claim 2, comprising:
following each of one, some or all of said search steps for each point, pruning away lower scoring ones of the paths based on the probability scores, thus leaving only one or some of the paths remaining;
wherein for each of said plurality of points, in each of the successive search steps, said set of preceding paths to be expended are the paths remaining after any pruning.

4. The method of claim 3, wherein the method comprises:
following each of some or all of the search steps, skimming off the element or combination of elements from each of some or all of the paths generated from across some or all of the points in the sequence into a candidate pool, the element or combination of elements from each of the skimmed-off paths forming a respective candidate result in the candidate pool; and
applying a fourth neural network to each entry to generate a new probability score for each candidate result in the candidate pool;
wherein said comparing comprises comparing the new probability scores in the candidate pool, and said selection comprises a selection of one or more of the candidate results having the highest of the new probability scores;
wherein said skimming comprises, for each current one of the search steps, after the current search step is completed across all the points in the sequence, skimming off the element or combination of elements from each of only a selected subset of the paths generated in the current search step into the candidate pool as candidate results, wherein the subset is selected as those paths having greater than a threshold probability score, or those in a highest portion according to the probability score; and
wherein the selected subset is selected only from amongst the paths remaining after the pruning in the current search step.

5. The method of claim 1, wherein each successive search step does not proceed for any of the points until the immediately preceding search step has been performed for all of the points.

6. The method of claim 1 comprising, for each respective one of said points:
prior to the first search step, generating a respective embedding for the respective point, the embedding being a vector generated by a second neural network as a function of some or all of the input elements before and/or after the respective point in the sequence, and as a function of the position of the respective point in the sequence;
wherein in the first search step for each of said points, the candidate elements of the respective one or more paths are generated based on a decoder state that is a function of the respective embedding.

7. The method of claim 6, wherein the method further comprises, for each of said points:
between each successive subsequent search step and the preceding search step, at least for the selected set of preceding paths, updating the decoder state as a function of the candidate elements in the respective preceding path;
wherein in each of the subsequent search steps, for each of the extended paths, the additional element of the respective path is generated based on the updated decoder state for the respective path.

8. The method of claim 6, comprising, for each respective one of said points:
prior to the first search step, generating a respective embedding for the respective point, the embedding being a vector generated by a second neural network as a function of some or all of the input elements before and/or after the respective point in the sequence, and as a function of the position of the respective point in the sequence;
wherein in the first search step for each of said points, the candidate elements of the respective one or more paths are generated based on a decoder state that is a function of the respective embedding;
wherein for each of said points, the probability score generated by the first neural network for each path in the first search step is also a function of an initial classifier for the respective position, the classifier representing a probability that the respective point has a missing or erroneous element; and
wherein the classifier is generated by a third neural network as a function of the respective embedding.

9. The method of claim 8, wherein the method comprises:
following each of some or all of the search steps, skimming off the element or combination of elements from each of some or all of the paths generated from across some or all of the points in the sequence into a candidate pool, the element or combination of elements from each of the skimmed-off paths forming a respective candidate result in the candidate pool; and
applying a fourth neural network to each entry to generate a new probability score for each candidate result in the candidate pool;
wherein said comparing comprises comparing the new probability scores in the candidate pool, and said selection comprises a selection of one or more of the candidate results having the highest of the new probability scores; and
wherein some or all of the first, second, third or fourth neural networks are subgraphs of the same wider network, and are trained together.

10. The method of claim 1, wherein for each of said points, the probability score generated by the first neural network for each path in the first search step is also a function of an initial classifier for the respective position, the classifier representing a probability that the respective point has a missing or erroneous element.

11. The method of claim 10, wherein the classifier is generated by a third neural network as a function of some or all of the input elements before and/or after the respective point in the sequence, and as a function of the position of the respective point in the sequence.

12. The method of claim 1, wherein the method comprises:
following each of some or all of the search steps, skimming off the element or combination of elements from each of some or all of the paths generated from across some or all of the points in the sequence into a candidate pool, the element or combination of elements from each of the skimmed-off paths forming a respective candidate result in the candidate pool; and
applying a fourth neural network to each entry to generate a new probability score for each candidate result in the candidate pool;
wherein said comparing comprises comparing the new probability scores in the candidate pool, and said selection comprises a selection of one or more of the candidate results having the highest of the new probability scores.

13. The method of claim 12, wherein said skimming comprises, for each current one of the search steps, after the current search step is completed across all the points in the sequence, skimming off the element or combination of elements from each of only a selected subset of the paths generated in the current search step into the candidate pool as candidate results, wherein the subset is selected as those paths having greater than a threshold probability score, or those in a highest portion according to the probability score.

14. The method of claim 1 comprising, for each of said points:
prior to the first search step, including an end-of-sequence element in the input sequence at the end of the sequence to represent the end of the portion of input data, and/or including a start-of-sequence element in the input sequence at the start of the sequence to represent the start of the portion of input data; wherein the input elements of which the first, second, third and/or fourth neural network is a function include the end-of-sequence element and/or the start-of-sequence element.

15. The method of claim 1, wherein in one, some or all of the search steps for each of some or all of the points, the generating of the paths comprises generating a respective set of multiple paths for each respective one of at least some said points, the multiple paths for the respective point each comprising a different candidate element and associated probability score based on the first neural network.

16. The method of claim 15, wherein amongst the multiple paths for each respective point having multiple paths in the current search step, the candidate elements for one of the paths includes a rejoin-sequence element representing stopping the search for the respective point and rejoining the candidate element or elements from the preceding search steps to the input sequence.

17. The method of claim 1, wherein said points are gaps between the input elements where missing data is potentially to be imputed.

18. The method of claim 1, wherein the portion of input data comprises a portion of text, and the elements from the received text are words or characters.

19. A computer program comprising code embodied on computer readable storage and configured so as when run on a computer apparatus to perform operations of automatically:
dividing a portion of input data into a sequence of smaller input elements;
identifying a plurality of points in the sequence at which missing or erroneous data is potentially to be imputed;
for each respective one of said points:
in a first search step, generating a respective set of one or more paths for the respective point, wherein each path comprises a candidate element to potentially replace the missing or erroneous data at the respective point, and an associated probability score, the probability score being generated by a first neural network as a function of some or all of the input elements before and/or after the respective point in the sequence, and
in each of a plurality of subsequent successive search steps, selecting a set of one or more of the preceding paths from one or more of the preceding search steps to extend, the selection being based on the associated probability scores, and generating a respective set of one or more extended paths from each respective one of the selected set of preceding paths, each extended path comprising the candidate element or elements from the respective preceding path combined with an additional candidate element, and an associated probability score for the combination, this probability score being generated by the first neural network as a function of some or all of the input elements before and/or after the respective point in the sequence, and as a function of the probability score for the respective preceding path; and
performing a comparison between at least some of the paths including comparing between paths from different ones of the search steps, and based thereon outputting a selection of one or more results wherein each result comprises the respective element or combination of elements of a respective one of the compared paths.

20. Computer apparatus programmed to perform operations of automatically:
dividing a portion of input data into a sequence of smaller input elements;
identifying a plurality of points in the sequence at which missing or erroneous data is potentially to be imputed;
for each respective one of said points:
in a first search step, generating a respective set of one or more paths for the respective point, wherein each path comprises a candidate element to potentially replace the missing or erroneous data at the respective point, and an associated probability score, the probability score being generated by a first neural network as a function of some or all of the input elements before and/or after the respective point in the sequence, and
in each of a plurality of subsequent successive search steps, selecting a set of one or more of the preceding paths from one or more of the preceding search steps to extend, the selection being based on the associated probability scores, and generating a respective set of one or more extended paths from each respective one of the selected set of preceding paths, each extended path comprising the candidate element or elements from the respective preceding path combined with an additional candidate element, and an associated probability score for the combination, this probability score being generated by the first neural network as a function of some or all of the input elements before and/or after the respective point in the sequence, and as a function of the probability score for the respective preceding path; and
performing a comparison between at least some of the paths including comparing between paths from different ones of the search steps, and based thereon outputting a selection of one or more results wherein each result comprises the respective element or combination of elements of a respective one of the compared paths.
